(19) United States
(12) Patent Application Publication
(10) Pub. No.: US 2002/0059368 A1
(43) Pub. Date: May 16, 2002

(54) Wireless remote computer interface system

(75) Inventor: Timothy A. Reynolds, Palm Bay, FL (US)

Correspondence Address: CHRISTOPHER F. REGAN, ESQUIRE, ALLEN, DYER, DOPPELT, MILBRATH & GILCHRIST, P.A., P.O. Box 3791, Orlando, FL, 32802-3791, US

(73) Assignee: Soneticom, Inc.

(21) Appl. No.: 09/754,749

(22) Filed: Jan. 4, 2001

Related U.S. Application Data
(60) Provisional application No. 60/175,151, filed on Jan. 7, 2000.

(51) Int. Cl. G06F 15/16

(52) U.S. Cl. 709/203

(57) ABSTRACT

To provide remote wireless interface with a computer, a fixed base station is coupled to output ports of the host computer and receives computer output signals intended for application to one or more computer output devices, such as a speaker and video display. The base station includes a transceiver that transmits wireless communication signals over a wireless communication link to a portable input/output unit. The portable input/output unit contains a set of input/output devices through which a user may interact with the host computer. It also includes a transceiver which conducts bidirectional wireless communications with the base station via the wireless communication link. As a result output device signals from the computer are transmitted to and drive output devices of the remote unit. In a complementary manner, input device signals associated with a user's operation of one or more input devices of the portable unit are transmitted to the base station and applied therefrom as inputs to the computer.

### CROSS-REFERENCE TO RELATED APPLICATION

The present application claims the benefit of co-pending U.S. Provisional Patent Application Serial No. 60/175,151, filed Jan. 7, 2000, entitled: “Wireless Remote Computer Interface System,” by T. Reynolds, assigned to the owner of the present application and the disclosure of which is incorporated herein.

### FIELD OF THE INVENTION

The present invention relates in general to communication systems and components therefor, and is particularly directed to a reduced complexity and relatively compact arrangement, for providing robust, wireless remote and portable input/output interface capability with the full functionality of a computer and associated peripherals, within a practical wireless environment, such as an office, small office/home office, industrial facility and the like.

### BACKGROUND OF THE INVENTION

Although the computer industry has enjoyed substantial diversification of its products among a wide variety of customers, including military, industrial, educational, business and household users, there has been very little development of the configuration of the personal computer (PC) workstation, the complexity and size of which may vary over a wide range of variables, including processing power and speed, mass storage, communication capability, etc. The user's concern is the ability to interact with the workstation, typically by means of one or more input devices, such as a keyboard, pointer (e.g., mouse, joystick), etc, and one or more real time output devices, such as a monitor and a set of speakers.

Even though such input/devices are simply a means to supply inputs to and receive information from the computer, the fact that they are part of a stationary workstation cluster (typically consisting of a computer, monitor, speakers, keyboard, mouse, and one or more optional peripherals, such as a printer, scanner, wireline or wireless communication devices, etc.), means that the user must be physically located at the workstation cluster in order to use it—thereby constraining user mobility and flexibility.

### SUMMARY OF THE INVENTION

In accordance with the present invention, such limitations of a conventional personal computer workstation are effectively obviated by means of a new and improved computer interface system, which is not a computer in and of itself, in the sense of the computer workstation it interfaces, but provides input/output capability in the form of a relatively compact and portable architecture, that provides the user with interactive access to the computer, and thereby to associated mass storage, high bandwidth communications, printing, and other capabilities of a workstation, in an untethered, wireless environment. The invention thus effectively removes mobility limitations on the user in the context of accessing all the functionality of the computer and associated peripherals, by providing the user with robust wireless data networking connectivity substantially anywhere within a practical wireless environment, such as an office, small office/home office, industrial, or outdoor environment.

For this purpose, the wireless computer interface system of the present invention comprises two components: 1— a fixed wireless base station connected to a host computer; and 2— a portable wireless remote platform, that provides user input/output capability with the computer to which the base station is connected. Namely, the base station provides a bidirectional interface between the remote unit and the host computer. It is interfaced with input/output ports of the computer, and is operative to conduct wireless communications with the wireless remote unit via a wireless communication link that employs an unlicensed portion of the RF spectrum. The remote unit includes one or more input devices, such as a touchpad pointer device and keyboard, through which the user remotely supplies input commands to the computer, as well as one or more output devices, such as a flat panel display and audio speakers, that are driven by output signals sourced by the computer.

In the output direction from the host computer to an output device of the remote unit, the base station is operative to process audio and video signals into encoded format for transmission as a composite data signal over the wireless communication link. In the input direction to the host computer from an input device on the remote unit, the base station is directly interfaced with pointer device and keyboard input ports of the computer. The base station is operative to provide substitute replications of pointer and keyboard signals the computer would normally expect to see coming from a desktop situated pointer device and the keyboard. For this purpose, the base station is configured to receive and demodulate wireless communication signals transmitted from the remote unit, which contain information representative of user manipulations of associated pointer device and keyboard elements installed in the remote unit.

In order to provide bidirectional interface functionality between the remote unit and the host computer, the base station includes a set of industry standard PC connection ports that interface respective audio, video, pointer device and keyboard signals with associated ports of the host computer. The audio and video signals are digitized and applied to a digital signal processor (DSP), which performs all supervisory control and signal processing functions of the base station. The DSP multiplexes the audio and video signals into a composite data stream, which is then encoded and compressed for transmission. The compression scheme may be selected from a variety of standard encoding applications, such as motion pictures expert group (MPEG) video encoding, digital television (DTV) encoding. The encoded composite (audio/video) data stream is digitally filtered and applied as a modulated baseband signal to a transmitter, the output of which is coupled to an antenna for RF transmission to the remote unit.

In the input direction from the remote unit to the computer, multiplexed encoded digitized pointer and keyboard data, as contained in a modulated RF signal received by the base station antenna and downconverted by a receiver unit are supplied to the base station DSP. The composite encoded (pointer/keyboard) signals are demodulated, decoded and demultiplexed by the DSP into pointer and keystroke associated signals for application to pointer device and keyboard ports of the host computer.

The remote unit comprises a pair of receiver and transmitter units, which respectively employ the same receiver and transmitter functionality as the receiver and transmitter units of the base station. In the input direction to the user, the remote unit's receiver outputs a multiplexed encoded digitized audio/video data signal to a DSP, which performs all supervisory control and signal processing functions for the remote unit, including negotiating the wireless channel to be used for a communication session with the base station. The composite encoded audio/video signal is demodulated, decoded and demultiplexed by the DSP into respective audio and video channels for application to associated speakers and a display contained in the remote unit.

In the output direction from the user to the computer, the remote unit's DSP multiplexes and encodes digitized pointer and keystroke signals supplied from a pointer device (e.g., touchpad, pointer stick) and a keyboard unit of the user interface. The encoded composite (pointer/keystroke) data stream is digitally filtered and applied as a modulated baseband signal to the transmitter for transmission over the wireless link to the base station.

### BRIEF DESCRIPTION OF THE DRAWINGS

FIG. 1 diagrammatically illustrates a preferred embodiment of the wireless computer interface system of the present invention;

FIG. 2 diagrammatically illustrates the architecture of a wireless base station of the wireless computer interface system of FIG. 1;

FIG. 3 diagrammatically illustrates a transmitter unit employed in the base station and remote unit of the wireless computer interface system of FIG. 1;

FIG. 4 diagrammatically illustrates a receiver unit employed in the base station and remote unit of the wireless computer interface system of FIG. 1;

FIG. 5 diagrammatically illustrates the architecture of the remote unit of the wireless computer interface system of FIG. 1; and

FIG. 6 is a table of examples of unlicensed wireless communication protocols that may be employed in the system of FIG. 1.

### DETAILED DESCRIPTION

Before describing in detail the new and improved wireless computer interface system of the present invention, it should be observed that the invention resides primarily in modular arrangements of conventional communication circuits and input/output devices and components therefor. In terms of a practical implementation that facilitates their manufacture, these modular arrangements may be readily configured using field programmable gate array (FPGA) and application specific integrated circuit (ASIC) chip sets, and commercially available input/output devices and components. As a consequence, the configurations of these arrangements and the manner in which they are interfaced with the input/output ports of a stand alone computer workstation have been illustrated in readily understandable block diagram format, which shows only those specific details that are pertinent to the present invention, so as not to obscure the disclosure with details that are readily apparent to one skilled in the art having the benefit of present description.

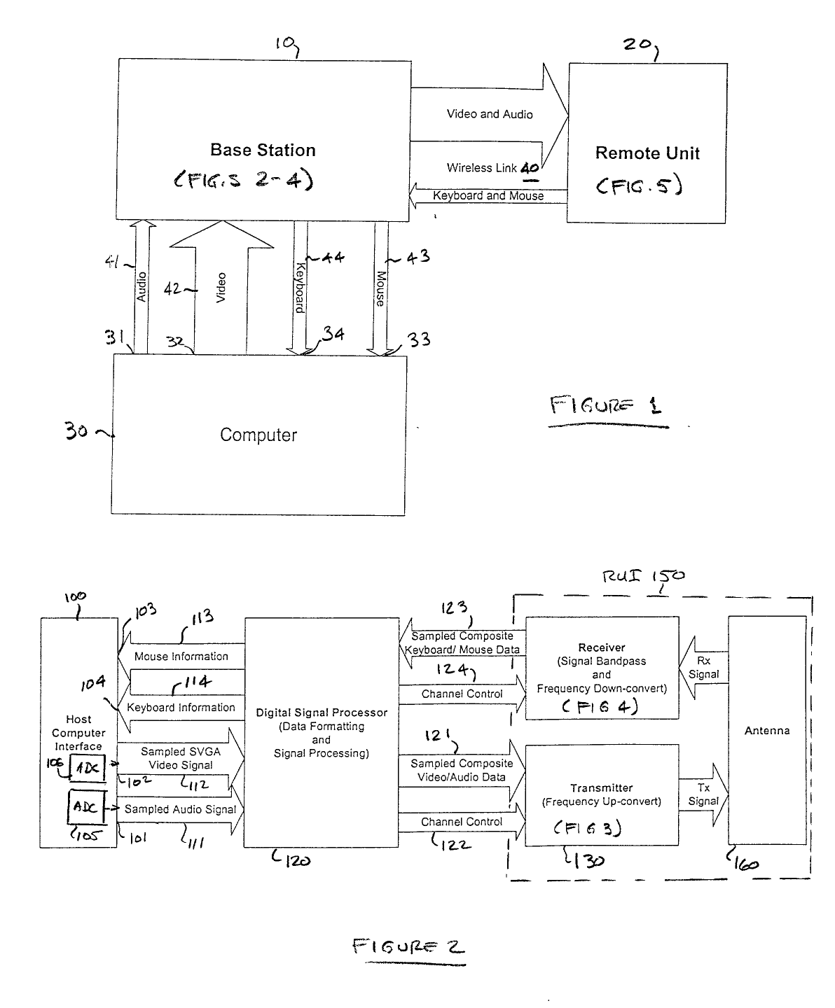

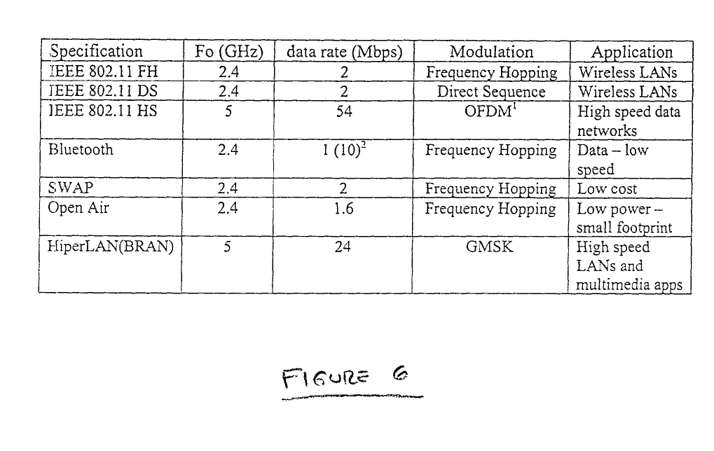

A non-limiting, but preferred embodiment of the wireless computer interface system of the present invention is diagrammatically illustrated in FIG. 1 as comprising a wireless base station 10 and a (portable) wireless remote input/output unit 20. The base station 10 (to be described in detail below with reference to FIGS. 2-4), serves as a bidirectional interface between the remote unit 20 and a host computer 30. As such the base station is configured to be directly interfaced with input/output ports of the host computer 30 and may be physically installed at the workstation containing the host computer. Regardless of its installed location the base station 10 is operative to conduct wireless communications with the wireless remote unit 20 via a wireless communication link 40. The remote unit 20 (to be described in detail below with reference to FIG. 5), is configured as a portable input/output device. Via the wireless link 40 with the base station, the remote unit interfaces input commands to the computer supplied by one or more input devices as operated by the user. It also receives output device associated signals from the computer for conveying information to the user via one or more output devices contained in the remote unit.

For this purpose, in the output direction (from the host computer to an output device), the base station 10 is directly interfaced with a set of audio and video output ports 31 and 32 of the host computer 30, by means of associated audio and video links 41 and 42. These links convey supply respective audio and video output signals from the computer that would normally be applied to an associated set of speakers and a display monitor (not shown) installed at the computer workstation. As will be described, the wireless base station 10 is operative to process these audio and video signals into encoded format for transmission as a composite data signal over a wireless communication link 40 to the remote unit 20.

In the input direction (to the host computer from an input device on the remote unit), the base station 10 is directly interfaced with a set of pointer device (e.g., mouse, stick, touchpad, and the like) and keyboard input ports 33 and 34 of the host computer 30, by means of associated mouse and video keyboard links 43 and 44, over which pointer and keyboard input signals source from a pointer device and a keyboard (not shown) installed at the workstation, would normally be applied to the host computer 30. In order to provide substitute replications of pointer and keyboard signals the host computer 30 would normally expect to see coming from its associated pointer device and keyboard, the base station 10 is configured to receive and demodulate wireless communication signals, that are transmitted over the wireless communication link 40 from the remote unit 20, and which contain information representative of user manipulations of associated pointer device and keyboard elements of a set of input devices installed on the remote unit 20, as will be described.

Referring now to FIG. 2, the architecture of the wireless base station 10 is diagrammatically illustrated as comprising a host computer interface 100, which includes a set of industry standard PC connection ports 101, 102, 103 and 104, that interface respective audio, video, pointer device and keyboard signals with ports 31, 32, 33 and 34 of the host computer 30. As a non-limiting examples, for the output direction, audio port 101 may comprise an industry standard one-eighth inch stereo phono jack with a line level audio output, while video port 102 may comprise an industry standard HD15 SVGA (1024×768×256 color MAX) port. For the input direction, the pointer device port 103 may comprise a standard PS-2 Mouse Interface, and keyboard port 104 may comprise a standard PS-2 Keyboard Interface.

The host computer interface 100 further includes an audio signal-sampling, analog-to-digital converter (ADC) 105, which is operative to digitize (sample) the audio signals coupled to the audio port 101 for application over a digital audio link 111 to a digital signal processor (DSP) 120, which performs all supervisory control and signal processing functions of the base station. Likewise, a video signal-sampling ADC 106 is coupled to digitize the video signals coupled to port 102 for application over a digital video link 112 to the DSP 120. This and similar digitizing of intermediate frequency (IF) signals for received RF transmissions from the remote terminal (to be described) ensures that all analog signal processing is isolated to the appropriate interface with the DSP 120, which processes only digitally formatted signals. The digitally formatted pointer and keyboard associated signals as recovered by the DSP 120 from a transmission received from the remote unit are supplied to the host computer interface 100 by digital links 113 and 114, respectively.

In the output direction (to the remote unit 20), digitized audio and video information supplied over links 111 and 112 from the host computer interface 100 are multiplexed into a composite data stream and then encoded. In order to provide full fidelity and resolution of the video signal for display on an associated video display contained in the remote unit, the video “dot rate” may be computed using standard display processing practice as follows. Dot rate=(horizontal resolution)×(vertical resolution)×(refresh rate)/(retrace rate). For a 1024×768 pixel screen at 60 Hz (non-interlaced) refresh rate, and a 0.8 retrace rate, the dot rate is 58.98 MHz. However, if the color palette provides full (RGB 24-bit) encoding resolution, then the effective RGB full screen rate is 24 times the clock rate (here 58.98 MHz) or approximately 1.42 Gbps. If the color palette is limited to only eight bits (256 colors), then the effective RGB full screen rate is still a very large 472 Mbps. Thus in either case the video signal must be compressed prior to wireless transmission.

The video compression scheme may be selected from a variety of standard encoding applications, such as motion pictures expert group (MPEG) video encoding, which is an ISO standard (ISO/IEC 13818-1) and commonly employed by satellite broadcast TV providers, and digital television (DTV) encoding. The resulting DTV composite payload consisting of video, audio, control and ancillary channel data has a composite data rate of 19.28 Mbps, which is well below the uncompressed eight bit color 1024×768 screen rate of 472 Mbps of the present example. Using the eight vestigial sideband (8-VSB) modulation of the DTV standard, the 19.28 Mbps compressed video/audio payload may be transmitted over a 6 MHz channel bandwidth. When using DTV compression, its physical and link layer protocols may be replaced with those employed for local area networks (LANs), which are more cost effective and robust in a multi-user environment.

The encoded composite (audio/video) data stream is digitally filtered by a digital baseband shaping filter within the DSP 120 and applied as a modulated baseband signal over a data link 121 to a transmitter 130 (to be described with reference FIG. 3) of a remote unit interface (RUI) 150. The transmitter 130 also receives transmission channel control signals from the DSP 120 over a channel control link 122. The output of the transmitter 130 is coupled to an antenna 160 for RF transmission to remote unit 20.

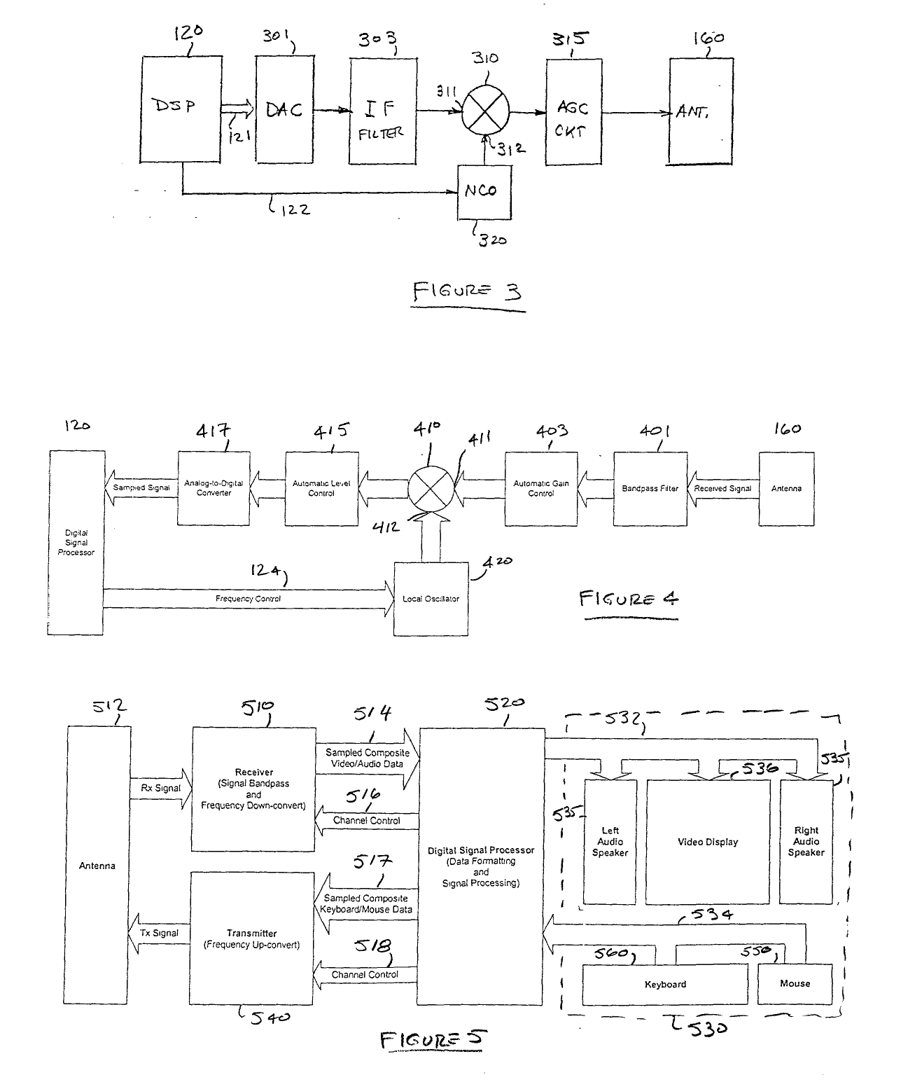

For the input direction (from the remote unit 20 to the computer 10), multiplexed encoded digitized pointer and keyboard data, is received by the antenna 160 and coupled to a receiver unit 140 (shown in FIG. 4, to be described) of the RUI 150, and supplied to the DSP 120 over a link 123. Receiver channel control signals are coupled from the DSP 120 to the receiver unit 140 over a control channel link 124. The composite encoded pointer and keyboard signal is demodulated, decoded and demultiplexed by the DSP 120 into pointer and keystroke associated signals over respective links 113 and 114 to the host computer interface 100.

The transmitter unit 130 of the RUI 150 is diagrammatically illustrated in FIG. 3 as comprising a digital-to-analog converter (DAC) 301, which is coupled to convert the encoded composite digitized audio/video signals supplied from the DSP 120 over link 121 into analog format for application to an intermediate frequency (IF) filter 303. The output of IF filter 303 is coupled to a first input 311 of an up-converting mixer 310. Mixer 310 has a second input 312 coupled to a numerically controlled oscillator (NCO) 320. The frequency of the NCO 320 is controlled by the DSP 120 via the transmitter control channel link 122. Mixer 310 outputs an up-converted radio frequency (RF) output signal to an automatic gain control (AGC) circuit 315, which is also coupled to receive a gain adjustment command signal supplied over the transmitter control channel link 122 from the DSP 120, for adjusting the output power level of the transmitted signal. The output of the AGC circuit 315 is coupled to the antenna 160 for wireless transmission to the remote unit. For the non-limiting example of employing a communication frequency of 2.4 GHz (the wavelength of which is on the order of five inches), antenna 160 may be configured as a quarter-wavelength antenna approximately one and one-quarter inches in length, providing an efficient antenna without unduly constraining mechanical design.

As described briefly above, the wireless communication link preferably uses an FCC “unlicensed” portion of the communication spectrum, such as the 2.4 GHz band, employing frequency hopping or direct sequence spread spectrum modulation formats, or the 5.0 GHz band utilizing orthogonal frequency division multiplexing (OFDM) or GMSK modulation. As a non-limiting example, the wireless protocol employed for the wireless communication channel 40 may comprise the IEEE 802.11 HS (high speed) standard using OFDM supporting data rates up to 54 Mbps, or the European developed Hyper LAN (aka Broadband Radio Access Networks or BRAN) standard supporting data rates of 24 Mbps using GMSK. These and other non-limiting examples of wireless communication protocols tabulated in FIG. 6 provide for robust high-speed wireless data networking connectivity in office, small office/home office, industrial and outdoor environments.

The receiver unit 140 of the RUI 150 is diagrammatically illustrated in FIG. 4 as comprising a bandpass filter 401, which is coupled to filter the output of antenna 160, to improve the sensitivity and dynamic range of the signal received from the remote unit 20. The filtered output by the bandpass filter 401 is coupled to an AGC circuit 403, the output of which is coupled to a first input 411 of a down-converting IF mixer 410. A second input 412 of the IF mixer 410 is coupled to the output of an NCO 420, the frequency of which is controlled by the DSP 120 via receiver control channel link 124. The IF mixer 410 outputs a down-converted IF signal to an automatic level control circuit 415, which serves to ensure a uniform signal amplitude for application to an ADC 417. The ADC 417 outputs a digitized IF signal containing the modulated pointer/keystroke data to the digital link 123 for application to the DSP 120.

FIG. 5 diagrammatically illustrates the architecture of the remote unit 20 as comprising a receiver unit 510, which employs the same receiver functionality as the receiver unit 140 of the base station 10, described above with reference to FIG. 4. Namely, in the input direction (to the user) the receiver unit 510 is coupled to the output of an antenna 512, which is configured to detect the RF transmission (e.g., at 2.4 GHz) from the base station 10, and outputs a multiplexed encoded digitized audio/video data signal to a DSP 520 over a received data link 514. As in the base station 10, the DSP 520 performs all supervisory control and signal processing functions for the remote unit 20. This includes establishing the wireless link 40 by negotiating the wireless channel to be used for a communication session, using standard wireless channel establishment procedures. Receiver channel control signals are coupled from the DSP 520 to the receiver unit 510 over a receiver channel control link 516. The composite encoded audio/video signal is demodulated, decoded and demultiplexed by the DSP 520 into respective audio and video channels for application to an output bus 532 to which respective speaker and display units 535 and 536 of a user interface 530 are coupled. The remote units user interface 530 may employ the same set of industry standard PC input/output connection ports employed by the host computer interface 100 of the wireless base station 10, described above.

In the output direction (from the user), the DSP 520 is coupled to multiplex and encode digitized pointer and keystroke signals supplied from an input bus portion 534 of the user interface 530 into a composite (pointer/keystroke) data stream. Input bus portion 534 is coupled to receive respective pointer movement signals from a pointer device (e.g., touchpad, pointer stick) 550 and keystroke signals from a keyboard unit 560 of the user interface 530. The encoded composite (pointer/keystroke) data stream is digitally filtered by a digital baseband shaping filter within the DSP 520 and applied as a modulated baseband signal over a transmission data link 517 to a transmitter 540. Like remote unit receiver unit 510, which is configured to perform the same functionality as the receiver 140 in the base station 10, the remote unit's transmitter 540 employs the same transmitter functionality as the transmitter 130 in the base station 10. The transmitter 540 receives transmission channel control signals over a transmission data link 518. The output of the transmitter 540 is coupled to the antenna 512 for transmission to the base station 10.

As will be appreciated from the foregoing description, the wireless computer input/output interface system of the present invention effectively obviates user location limitations imposed by a conventional personal computer workstation, so that the user may have mobile interactive access with the computer, and its associated mass storage, high bandwidth communications, printing, and other capabilities of a workstation or server substantially anywhere within a practical wireless environment, such as an office, small office/home office, industrial, or outdoor environment.

As a non-limiting example of a ‘household’ setting, the invention allows a consumer ready access to an office or den-located computer from a relatively remote location, such as kitchen, patio, garage, bedroom, etc., thereby facilitating access to the internet, word processing application, games, etc. In a mobile environment, such as an automobile, wireless connectivity with GPS capability allows the mobile computer (CPU) to be installed in an “out of the way” location in the vehicle. The invention is thereby capable of providing any of a variety of computer related functions, such as access to information, real time tracking, communications, the ability to play games, and access the internet from inside the vehicle.

In a business environment, the invention may be used in any office, where connectivity of a computer connected to a corporate network, printer and internet access, is required, while also providing a light weight terminal to view information. Similarly, the invention may be readily employed in a teaching or training application, where multiple terminals are used in a read-only manner, in order to send information to a number of private screens where overhead displays are in appropriate, such in a judicial, medical, or military application.

While I have shown and described an embodiment in accordance with the present invention, it is to be understood that the same is not limited thereto but is susceptible to numerous changes and modifications as known to a person skilled in the art, and I therefore do not wish to be limited to the details shown and described herein, but intend to cover all such changes and modifications as are obvious to one of ordinary skill in the art.

What is claimed:

1. A system for providing remote wireless interface connectivity with a host computer comprising:
a fixed wireless base station connected to said host computer, and providing a bidirectional communication interface between a portable wireless remote unit and said host computer, said wireless base station being interfaced with input/output ports of said host computer, and being operative to conduct bidirectional wireless communications with said portable wireless remote unit via a wireless communication link;
a portable wireless input/output unit that provides user input/output capability with said computer, said portable wireless remote unit containing one or more input devices, through which a user remotely supplies input commands to said host computer, and one or more output devices, that are driven by output signals sourced by said host computer, and a transceiver which is operative to conduct bidirectional wireless communications with said base station via said wireless communication link.

2. A system according to claim 1, wherein said base station is configured to process audio and video signals output by said host computer into digitally encoded format for transmission as a composite signal over said wireless communication link, and to provide to said host computer substitute replications of pointer and keyboard signals that said host computer would normally receive from a locally situated pointer device and keyboard, in accordance with wireless communication signals transmitted from said remote unit, and which contain information representative of user manipulations of associated pointer device and keyboard elements installed in said remote unit.

3. A system according to claim 2, wherein said base station includes a digital signal processor that is operative to multiplex encode and compress digitized computer audio and video signals into a composite data stream for transmission over said wireless communication channel to said remote unit, and to demodulate, decode and demultiplex composite encoded pointer/keyboard signals transmitted over said wireless communication channel from said remote into pointer and keystroke associated signals for application to pointer device and keyboard ports of said host computer.

4. A system according to claim 3, wherein said remote unit transceiver includes a receiver that is operative to output a multiplexed encoded digitized audio/video data signal received from said base station to an associated remote unit digital signal processor, wherein said multiplexed encoded digitized audio/video data signal is demodulated, decoded and demultiplexed into respective audio and video channels for application to associated speakers and a display of said remote unit, and to multiplex and encode digitized pointer and keystroke signals, supplied from a pointer device and keyboard unit of a remote unit-installed user interface, for transmission by a transmitter unit over said wireless communication link to said base station.

5. A system for providing a remote wireless interface with a computer comprising:
a base station coupled to output ports of said computer and being operative to receive therefrom computer output signals generated by said computer for application to one or more computer output devices associated therewith, and to transmit first wireless communication signals containing output device information representative of said computer output signals over a wireless communication link to a remote unit, and being operative to receive second wireless communication signals from said remote unit containing input device information representative of computer input signals to be coupled to input ports of said computer; and
a remote unit containing one or more remote unit output devices respectively corresponding to said one or more computer output devices, and being operative to receive said first communication signals transmitted over said wireless communication link from said base station and to couple remote unit output device signals to said one or more remote unit output devices containing said output device information representative of said computer output signals, and further containing one or more remote unit input devices, respectively corresponding to one or more computer input devices, and being coupled to receive therefrom input device signals representative of computer input signals to be applied to computer input ports of said computer, and to transmit said second wireless communication signals containing input device information representative of said input device signals over said wireless communication link to said base station.

6. A system according to claim 5, wherein said one or more computer output devices and remote unit output devices include audio and display devices, and said one or more computer input devices and remote unit input devices include a computer pointing device and a keyboard.

7. A method of providing remote wireless interface connectivity with a host computer comprising the steps of:
(a) interfacing with input/output ports of said host computer a fixed base station transceiver that is operative to conduct bidirectional wireless communications with a portable wireless input/output unit via a wireless communication link;
(b) providing a portable wireless input/output unit having user input devices through which a user remotely may supply input commands to said host computer, and output devices, that are driven by output signals sourced by said host computer, and a transceiver which is operative to conduct bidirectional wireless communications with said base station transceiver via said wireless communication link;
(c) establishing a wireless communication between said portable wireless input/output unit and said base station trasceiver;
(d) operating one or more input devices of said portable wireless input/output unit so as to supply input commands to said host computer by way of said wireless communication link and said base station transceiver; and
(e) operating one or more output devices of said portable wireless input/output unit in accordance with audio and/or video signals output by said host computer and transmitted to said portable wireless input/output unit over said wireless communication link from said base station transceiver.

8. A method according to claim 7, wherein said base station is configured to process audio and video signals output by said host computer into digitally encoded format for transmission as a composite signal over said wireless communication link, and to provide to said host computer substitute replications of pointer and keyboard signals that said host computer would normally receive from a locally situated pointer device and keyboard, in accordance with wireless communication signals transmitted from said remote unit, and which contain information representative of user manipulations of associated pointer device and keyboard elements installed in said remote unit.

9. A method according to claim 8, wherein said base station includes a digital signal processor that is operative to multiplex encode and compress digitized computer audio and video signals into a composite data stream for transmission over said wireless communication channel to said remote unit, and to demodulate, decode and demultiplex composite encoded pointer/keyboard signals transmitted over said wireless communication channel from said remote into pointer and keystroke associated signals for application to pointer device and keyboard ports of said host computer.

10. A method according to claim 9, wherein said remote unit transceiver includes a receiver that is operative to output a multiplexed encoded digitized audio/video data signal received from said base station to an associated remote unit digital signal processor, wherein said multiplexed encoded digitized audio/video data signal is demodulated, decoded and demultiplexed into respective audio and video channels for application to associated speakers and a display of said remote unit, and to multiplex and encode digitized pointer and keystroke signals, supplied from a pointer device and keyboard unit of a remote unit-installed user interface, for transmission by a transmitter unit over said wireless communication link to said base station.
